(19) United States
(12) Patent Application Publication
(10) Pub. No.: US 2009/0073716 A1
(43) Pub. Date: Mar. 19, 2009

(54) Line Illuminating Device

(75) Inventors: Makoto Ikeda, Tokyo (JP); Atsuya Kanno, Tokyo (JP)

Correspondence Address: CARRIER BLACKMAN AND ASSOCIATES, 24101 NOVI ROAD, SUITE 100, NOVI, MI, 48375, US

(73) Assignee: Nippon Sheet Glass Company Limited, Tokyo (JP)

(21) Appl. No.: 12/284,019

(22) Filed: Sep. 17, 2008

(30) Foreign Application Priority Data
Sep. 19, 2007 (JP) 2007-242784

(51) Int. Cl. G02B 5/02

(52) U.S. Cl. 362/558

(57) ABSTRACT

There is provided a line illuminating device in which a rod-shaped light guiding member is incorporated, the light guiding member producing substantially no color variation in the vicinity of the end on which light is incident. A light scattering pattern 20 for scattering incident light is integrally formed in a bottom surface 11b of a rod-shaped light guiding member 11. The light scattering pattern 20 is comprised of a large number of recesses 21. The recess 21 is shaped into a triangular groove with its longitudinal direction being the short-side direction of the light guiding member 11. Inclined surfaces 22, 22 that form the triangular groove have a large number of minute recesses 23 formed integrally therewith. Each of the minute recesses 23 is a triangular groove along the longitudinal direction of the recess 21.

### BACKGROUND OF THE INVENTION

1. Field of the Invention

The present invention relates to a line illuminating device in which a light emitting unit is attached to a rod-shaped light guiding member.

2. Description of the Related Art

Any of a facsimile, a copier, a hand scanner, and other similar apparatus includes an image reader, such as an image sensor, as a device for reading a source document. Examples of the image sensor include a reduction type, a contact type, and a full contact type. Among them, a contact-type image sensor is formed of, for example, an illumination device, a unit magnification imaging optical device, and a sensor. Such a contact-type image sensor, in general, advantageously has a shorter optical path length, makes the size of the apparatus smaller, involves no tedious optical adjustment, and is readily incorporated in the apparatus, unlike a reduction-type image sensor. Contact-type image sensors have therefore replaced many reduction-type image sensors.

The illumination device in such a contact-type image sensor must be configured in such a way that the surface of a source document is illuminated to be brighter than or equal to the brightness that allows the sensor to read the document. The area to be illuminated by the illumination device is linear. The linear area may be very long in the main scanning direction (longitudinal direction), whereas being very short in the sub scanning direction perpendicular to the main scanning direction. That is, a line illuminating device is used.

The line illuminating device is configured in such a way that a rod-shaped light guiding member is housed in an enclosure and a light emitting unit (LED) is attached to an end of the enclosure. The light incident on an end of the rod-shaped light guiding member exits through an exit surface exposed through an opening of the enclosure toward the source document while being repeatedly reflected off inner surfaces of the light guiding member.

In the rod-shaped light guiding member, the light is less attenuated in portions close to the end to which the light emitting unit is attached, whereas significantly attenuated in portions closer to the other end. To address the problem, as described in Japanese Patent Laid-Open No. 2006-054635, a light scattering pattern that scatters and reflects light is formed on any side surface other than the exit surface by integrally molding recesses and protrusions or applying a white paint or any other similar material so as to make the intensity of the light that exits through the exit surface uniform along the longitudinal direction.

The light scattering pattern on a conventional light guiding member is formed by integrally molding recesses and protrusions or applying a white paint as described above. When a white paint is applied, however, a white paint must be separately prepared and the number of processes increases. Further, since the paint itself absorbs light, the amount of reflected light becomes insufficient.

On the other hand, when recesses and protrusions are integrally molded, the light will not be uniformly reflected off all the surfaces, and the intensity of the light that exits through the exit surface is likely non-uniform especially in portions close to the light emitting unit. Further, when a multicolor light emitting element is used in the light emitting unit, the intensity of the light for each color that exits through the exit surface is likely non-uniform in portions close to the light emitting unit. To avoid such a problem, an effective area of the irradiated surface in the main scanning direction must start from a point away from the light incident end typically by 4 mm or greater. In this case, however, part of the line illumination device is wasted.

Further, when the spine portion of a book is copied, or when a source document is crimped, part of the source document is lifted from a glass platen (source document bed), resulting in difference in the amount of irradiation light (the intensity of light that reaches the source document in each position in the main scanning direction) for colors. When there is difference in the amount of irradiation light for colors across the main scanning direction, the difference can be corrected on the light receiving side (by image processing in a light receiving element or in the apparatus), but such correction cannot address the difference in the amount of irradiation light for colors resulting from a lifted source document.

Japanese Patents Laid-Open Nos. 2001-147328, 2003-348299, and 2004-056425 are exemplified as other related art documents.

### SUMMARY OF THE INVENTION

To solve the above problems, the present invention provides a line illuminating device in which a light emitting unit is attached to an end of a rod-shaped light guiding member and illumination light incident on the end of the rod-shaped light guiding member exits through a flat exit surface provided along the longitudinal direction while being repeatedly reflected off inner surfaces of the light guiding member. The line illuminating device comprises a light scattering pattern provided at least on one of longitudinal side surfaces including the exit surface of the rod-shaped light guiding member, the light scattering pattern having recesses or protrusions formed continuously or discontinuously, and minute recesses or minute protrusions for more uniformly scattering the light that are formed on the surface of each of the recesses or protrusions. The light emitting unit includes a plurality of light emitting elements aligned with the normal passing through the center of a main light scattering pattern among the light scattering patterns, the center in the short-side direction when viewed from an end of the rod-shaped light guiding member.

It is noted that when only one side surface of the rod-shaped light guiding member has a light scattering pattern formed therein, the light scattering pattern is the main light scattering pattern. On the other hand, when a plurality of side surfaces of the rod-shaped light guiding member have respective light scattering patterns formed therein, the light scattering pattern formed in any one of the side surfaces is the main light scattering pattern.

The shape of the end of the recess or the protrusion is, for example, triangular. However, a semicircular or rectangular end is also conceivable. The plurality of light emitting elements may include a red light emitting element (R), a green light emitting element (G), and a blue light emitting element (B), but are not limited to this combination.

With the line illuminating device according to the invention, not only do the recesses or the protrusions that form the light scattering pattern scatter the light introduced in the light guiding member, but also the minute recesses or minute protrusions formed on the surface of each of the recesses or the protrusions further scatter the light, whereby the intensity of the light that exits through the exit surface becomes sufficiently uniform in the longitudinal direction. The effective area of the illuminated surface in the main scanning direction can thus start from the end on the light emitting unit side.

Further, according to the present invention, even when part of a source document is lifted, the amount of irradiation light for a color changes in the same manner as that for other colors in the lifted portion. There is thus no color variation (difference in the amount of irradiation light for colors in each position in the main scanning direction).

### BRIEF DESCRIPTION OF THE DRAWINGS

FIG. 1 is a side view of an image reader in which a line illuminating device according to the present invention is incorporated;

FIG. 2 is a perspective view of a rod-shaped light guiding member that forms the line illuminating device;

FIG. 3 is an enlarged view of a recess that is a component of a light scattering pattern formed in the rod-shaped light guiding member;

FIG. 4 is an enlarged view of a key portion of the recess;

FIG. 5 is an enlarged view of a protrusion that is a component of a light scattering pattern according to another embodiment;

FIGS. 6A to 6C show specific examples of the positional relationship between the light scattering pattern and light emitting elements;

FIGS. 6D to 6F show specific examples of the positional relationship between the light scattering pattern and light emitting elements;

FIGS. 7A to 7C are graphs showing the ratio of the amount of irradiation light of each color in the main scanning direction of the line illuminating devices having the positional relationships shown in FIGS. 6A to 6C; and

FIGS. 7D to 7F are graphs showing the ratio of the amount of irradiation light of each color in the main scanning direction of the line illuminating devices having the positional relationships shown in FIGS. 6D to 6F.

### DETAILED DESCRIPTION OF THE PREFERRED EMBODIMENTS

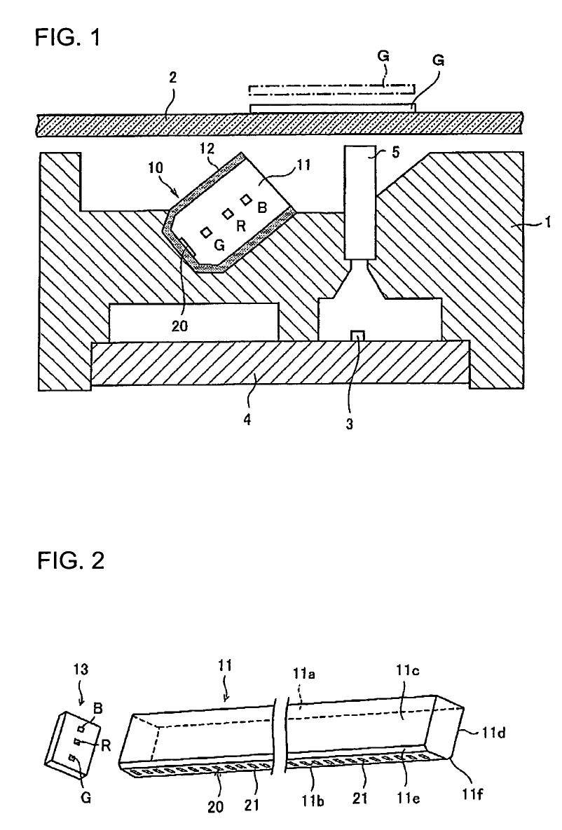

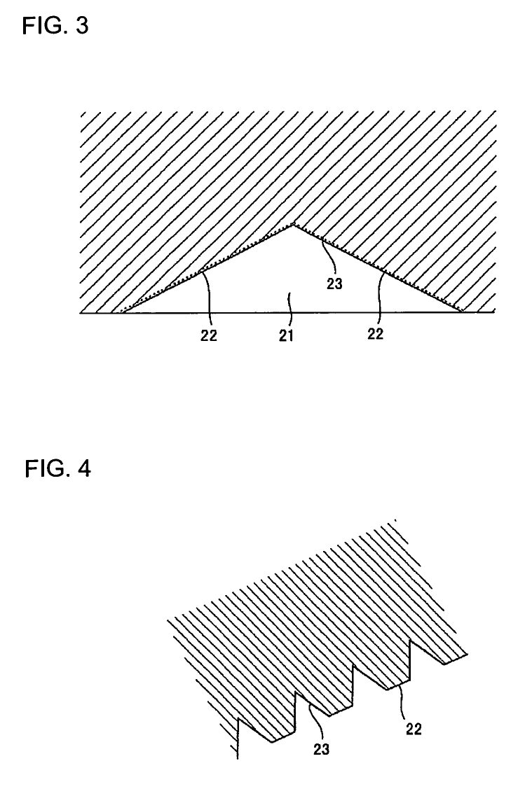

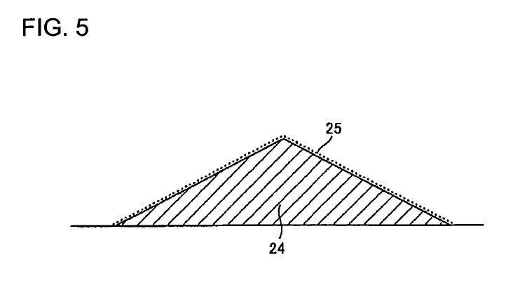

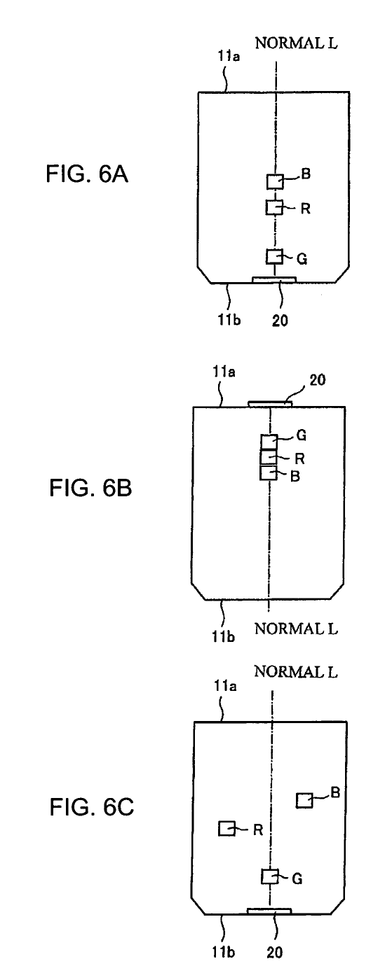

Preferred embodiments of the present invention will be described below with reference to the accompanying drawings. FIG. 1 is a side view of an image reader in which a line illuminating device according to the present invention is incorporated. FIG. 2 is a perspective view of a rod-shaped light guiding member that forms the line illuminating device. FIG. 3 is an enlarged view of a recess that is a component of a light scattering pattern formed in the rod-shaped light guiding member. FIG. 4 is an enlarged view of a key portion of the recess.

A frame (housing) 1 of the image reader is topped with a glass platen 2 on which a source document G is placed. A line illuminating device 10 is fixed to the frame 1 in an oblique direction (inclined to the horizontal direction by any angle larger than 0 degrees but smaller than or equal to 70 degrees). A sensor substrate 4 with a photoelectric conversion element (linear image sensor) 3 is placed at the bottom of the frame 1. The frame 1 further holds a unit magnification imaging rod lens array 5.

Illumination light from the line illuminating device 10 passes through the glass platen 2 and strikes the source document G, and the light reflected off the source document G passes through the rod lens array 5 and is detected by the photoelectric conversion element (linear image sensor) 3. The source document G is thus read in the direction perpendicular to the plane of view of FIG. 1 (main scanning direction). The frame 1 is then moved relative to the glass platen 2 in the right-left direction in FIG. 1 (sub scanning direction) to read a desired area of the source document G.

The line illuminating device 10 includes a light guiding member 11 housed in a white light guiding member enclosure 12 and a light emitting unit 13 provided at one end of the light guiding member 11. The light guiding member 11 is obtained by injection molding a transparent material, such as acrylic resin. The light guiding member 11 has a hexagonal cross-sectional shape when taken along the short-side direction thereof, but the shape is fairly close to a quadrangle.

That is, a longitudinal side surface exposed through an opening of the enclosure 12 is used as an exit surface, which is now called a top surface 11a. The light guiding member 11 has the top surface 11a, a bottom surface 11b, right and left side surfaces 11c, 11d, inclined surfaces 11e, 11f formed between the bottom surface 11b and the right and left side surfaces 11c, 11d, and two end surfaces.

The shape of the light guiding member 11 is not limited to the one described above. Other conceivable cross-sectional shapes taken along the short-side direction include a quadrangle, and a shape in which the inclined surfaces 11e and 11f are replaced with rounded surfaces.

A light scattering pattern 20 for scattering incident light is integrally formed in the bottom surface 11b of the rod-shaped light guiding member 11. The light scattering pattern 20 is comprised of a large number of recesses 21. The large number of recesses 21 may be evenly spaced apart, or may be more packed in portions farther away from the light emitting unit 13. In the latter case, the recess 21 located closer to the light emitting unit 13 may have a shorter length, whereas the recess 21 located farther away from the light emitting unit 13 may have a longer length.

The width of the recess 21 preferably ranges from 50 to 1000 μm, more preferably from 100 to 300 μm. The depth of the recess 21 preferably ranges from 25 to 500 μm, more preferably from 50 to 100 μm.

The recess 21 is shaped into a triangular groove with its longitudinal direction being the short-side direction of the light guiding member 11. Inclined surfaces 22 that form the triangular groove have a large number of minute recesses 23 formed integrally therewith. Each of the minute recesses 23 is a triangular groove along the longitudinal direction of the recess 21. The width of the minute recess 23 preferably ranges from 1 to 3 μm, and the depth of the minute recess 23 preferably ranges from 1 to 3 μm.

The shape of the recess 21 is not limited to the one described above. It is conceivable that the shape of the two ends of the recess 21 is rectangular, semi-circular, or semi-elliptical. The minute recess 23 is not limited to the recessed groove continuously extending in the longitudinal direction of the recess 21. Other conceivable minute recesses 23 may include a conical hole, a pyramidal hole, and a semispherical hole.

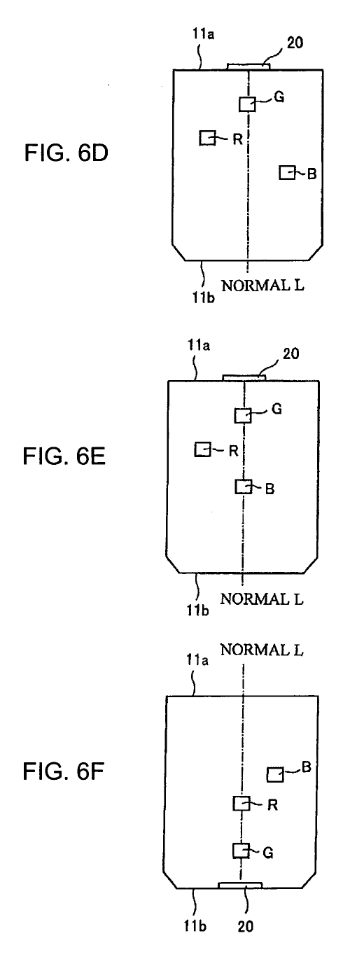

Further, as shown in FIG. 5, the recess 21 may be replaced with a protrusion 24 that is the reverse of the recess 21 (that is, the protrusion 24 corresponds to the mold used when the recess 21 is injection molded). The surface of the protrusion 24 has minute protrusions 25 formed thereon, and each of the minute protrusions 25 is the reverse of the minute recess 23. Alternatively, the surface of the recess 21 may have the minute protrusions 25 formed thereon, and the surface of the protrusion 24 may have the minute recesses 23 formed therein.

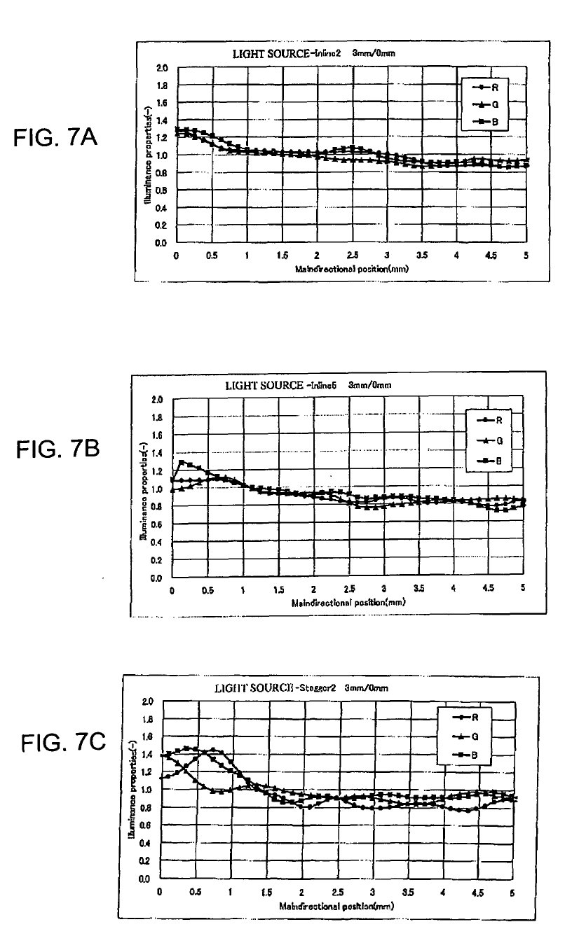

The light emitting unit 13 attached to one end of the light guiding member 11 includes a red light emitting element (R), a green light emitting element (G), and a blue light emitting element (B). FIGS. 6A to 6F show specific examples of the positional relationship between the light scattering pattern 20 and the light emitting elements.

In an exemplary arrangement shown in FIG. 6A, the light scattering pattern 20 comprised of the recesses 21 is formed in the bottom surface 11b of the light guiding member 11, and the green light emitting element (G), the red light emitting element (R), and the blue light emitting element (B) are aligned with the normal L passing through the center of the light scattering pattern 20, the center in the short-side direction viewed from an end of the rod-shaped light guiding member. In consideration of light intensity, the green light emitting element (G) is disposed in a position closest to the light scattering pattern 20, and the blue light emitting element (B) is disposed in a position farthest from the light scattering pattern 20. The light emitting elements are spaced apart from one another.

In an exemplary arrangement shown in FIG. 6B, the light scattering pattern 20 comprised of the protrusions 24, each of which being the reverse of the recess 21, is formed on the exit surface 11a of the light guiding member 11, and the green light emitting element (G), the red light emitting element (R), and the blue light emitting element (B) are aligned with the normal L passing through the center of the light scattering pattern 20, the center in the short-side direction viewed from an end of the rod-shaped light guiding member. The surface of the protrusion 24 has minute protrusions formed thereon. In consideration of light intensity, the green light emitting element (G) is disposed in a position closest to the light scattering pattern 20, and the blue light emitting element (B) is disposed in a position farthest from the light scattering pattern 20. The light emitting elements are arranged to be close to one another.

In an exemplary arrangement shown in FIG. 6C, the light scattering pattern 20 comprised of the recesses 21 is formed in the bottom surface 11b of the light guiding member 11. The green light emitting element (G) is aligned with the normal L passing through the center of the light scattering pattern 20, the center in the short-side direction viewed from an end of the rod-shaped light guiding member, and the red light emitting element (R) and the blue light emitting element (B) are disposed in positions offset from the normal L.

In an exemplary arrangement shown in FIG. 6D, the light scattering pattern 20 comprised of the protrusions 24, each of which being the reverse of the recess 21, is formed on the exit surface 11a of the light guiding member 11. The green light emitting element (G) is aligned with the normal L passing through the center of the light scattering pattern 20, the center in the short-side direction viewed from an end of the rod-shaped light guiding member, and the red light emitting element (R) and the blue light emitting element (B) are disposed in positions offset from the normal L.

In an exemplary arrangement shown in FIG. 6E, the light scattering pattern 20 comprised of the protrusions 24, each of which being the reverse of the recess 21, is formed on the exit surface 11a of the light guiding member 11. The green light emitting element (G) and the blue light emitting element (B) are aligned with the normal L passing through the center of the light scattering pattern 20, the center in the short-side direction viewed from an end of the rod-shaped light guiding member, and the red light emitting element (R) is disposed in a position offset from the normal L.

In an exemplary arrangement shown in FIG. 6F, the light scattering pattern 20 comprised of the recesses 21 is formed in the bottom surface 11b of the light guiding member 11. The green light emitting element (G) and the red light emitting element (R) are aligned with the normal L passing through the center of the light scattering pattern 20, the center in the short-side direction viewed from an end of the rod-shaped light guiding member, and the blue light emitting element (B) is disposed in a position offset from the normal L.

While FIGS. 6A to 6E show the cases where the light scattering pattern (main light scattering pattern) is formed in one side surface of the rod-shaped light guiding member, another light scattering pattern that assists the light scattering pattern (main light scattering pattern) may be formed in another side surface.

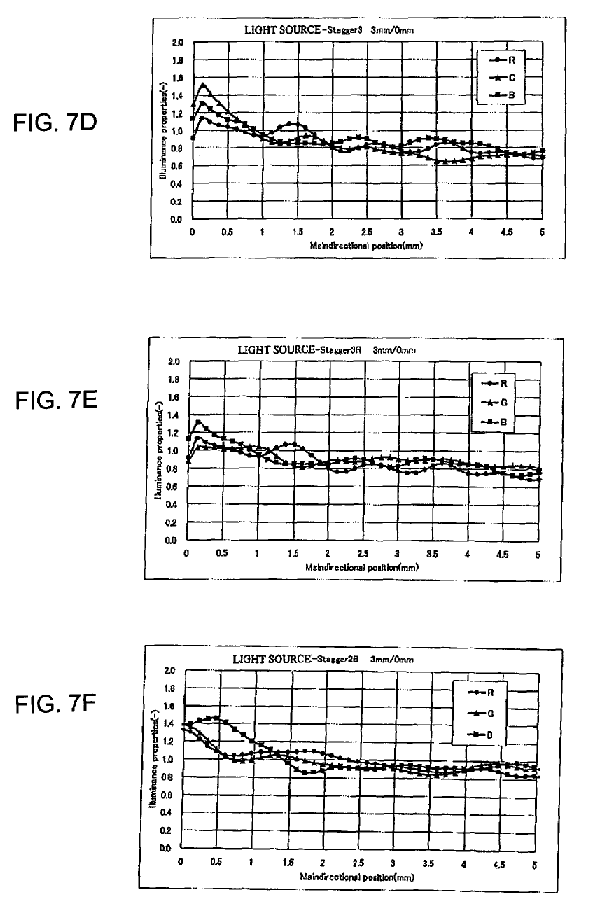

FIGS. 7A to 7F are graphs showing the ratio of the amount of irradiation light of each of the colors in the main scanning direction of the line illuminating devices having the positional relationships shown in FIGS. 6A to 6F. Each of the graphs covers a 5-mm range along the main scanning direction from the light emitting unit side end of the rod-shaped light guiding member. That is, the vertical axis represents the ratio (3 mm/0 mm) of the amount of irradiation light of each of the colors when a source document is on the glass platen, that is, lifted 0 mm above the glass platen, to the amount of irradiation light of the color when the source document is lifted 3 mm above the glass platen (G corresponds to the 0-mm level and G′ corresponds to the 3-mm level in FIG. 1).

The graphs show that the formation of the recesses 21 or the protrusions 24 as the light scattering pattern along with the minute recesses or protrusions on the surface of each of the recesses 21 or the protrusions 24 provides the same tendency of the change in the amount of irradiation light for the colors even in the vicinity of the end on the light emitting unit side even when part of the source document is lifted as indicated by G′ in FIG. 1, resulting in less color variation. In particular, it is shown that substantially no color variation occurs when the red light emitting element (R), the green light emitting element (G), and the blue light emitting element (B) are aligned with the normal L of the light scattering pattern 20.

It is also found that arranging the light emitting elements to be spaced apart from one another provides the same tendency of the change in the amount of irradiation light for the colors in the vicinity of the end on the light emitting unit side, resulting in no color variation. It is further found that the light scattering pattern 20 comprised of the protrusions 24 formed on the exit surface 11a of the light guiding member 11 causes less color variation in the vicinity of the incident end than the light scattering pattern 20 comprised of the recesses 21 formed in the bottom surface 11b of the light guiding member 11.

What is claimed is:

1. A line illuminating device in which a light emitting unit is attached to an end of a rod-shaped light guiding member and illumination light incident on the end of the rod-shaped light guiding member exits through a flat exit surface provided along the longitudinal direction while being repeatedly reflected off inner surfaces of the light guiding member, the line illuminating device comprising:
a light scattering pattern provided at least on one of longitudinal side surfaces including the exit surface of the rod-shaped light guiding member, the light scattering pattern having recesses or protrusions formed continuously or discontinuously; and
minute recesses or minute protrusions for more uniformly scattering the light that are formed on the surface of each of the recesses or protrusions,
wherein the light emitting unit includes a plurality of light emitting elements aligned with the normal passing through the center of a main light scattering pattern among the light scattering patterns, the center in the short-side direction when viewed from an end of the rod-shaped light guiding member.

2. The line illuminating device according to claim 1, wherein the shape of the end of the recess or the protrusion is triangular.

3. The line illuminating device according to claim 1, wherein the light emitting elements are spaced apart from one another.
